(19) United States
(12) Patent Application Publication
(10) Pub. No.: US 2014/0278562 A1
(43) Pub. Date: Sep. 18, 2014

(54) System and method for underwriting alimony and child support

(71) Applicants: David Platt, Boynton Beach, FL (US); Ronald H. Platt, Miami, FL (US)

(72) Inventors: David Platt, Boynton Beach, FL (US); Ronald H. Platt, Miami, FL (US)

(73) Assignee: David Platt, Boynton Beach, FL (US)

(21) Appl. No.: 13/826,413

(22) Filed: Mar. 14, 2013

(51) Int. Cl. G06Q 40/08

(52) U.S. Cl. CPC G06Q 40/08
USPC 705/4

(57) ABSTRACT

A sophisticated Underwriting system to Insure the continuation of Payments under a Child Support/Alimony/Prenuptial/Palimony/Civil Union agreement in the event of unintentional default and pay legal expenses for enforcement due to intentional default by the Payer is disclosed through which either party can purchase coverage.

### PRIORITY AND CROSS-REFERENCE TO RELATED APPLICATIONS

This application claims the benefit of U.S. Provisional Application No. 61/698,799, filed Sep. 17, 2012 which application is herein incorporated by reference in its entirety.

### FIELD OF THE INVENTION

Embodiments of the invention relate to a system that makes underwriting SUPPORT PAYMENTS INSURANCE profitable, affordable and thus available.

### BACKGROUND OF THE INVENTION

In 2009 the Census Bureau reported that there were approximately 13.7 million single parents, raising 21.8 million children, 41% of all new marriages end in divorce involving over one million children, the majority of payment defaults are as a result of death, disability, unemployment or a call to active military duty.

Family court Judges, domestic attorneys, child welfare agencies, single parents associations are searching for the answers of how to:
“Protect the supporting spouse and dependent children from the economic fallout of divorce by assuring the continuation of support payments.”
“Give the supporting spouse increased flexibility during settlement negotiations because the support is assured.”
“Help to neutralize the post-divorce environment by removing the punishment potential from withheld support.”

However, insurance companies are hesitant to offer support default insurance because of the risk that an applicant will apply for the insurance knowing in advance that they will become disabled, called to active military duty, be laid-off or have a terminal medical condition. To provide coverage to unqualified customers would be non-sustainable. Our underwriting system has shown to dramatically eliminate fraudulent claims and over utilization.

### SUMMARY OF THE INVENTION

The following presents a simplified summary of one or more embodiments of the invention in order to provide a basic understanding of such embodiments. The system comprises a computing platform including a processor and memory. The system further includes an underwriting request routine stored in the memory and executable by the processor. The underwriting request routine is configured to receive requests to enroll in the default insurance product, than process the applicant's information through a Credit rating bureau using our psychographic profiling system with specific critiques to determine financial eligibility and the Medical Information bureau to determine pre-existing conditions.

Embodiments of the underwriting analysis determines the amount of insurance needed to comply with the court order, or other legal agreement, if eligible the system calculates the premium.

This innovative underwriting system makes it possible to provide support payment insurance on a group discount basis through non profit associations, i.e. Single Parent Association of America and the Child Welfare League of America.

In another embodiment of this method of underwriting makes it possible for Family law firms to use an online system to make the insurance part of the settlement agreement, thus providing peace of mind to their client and a negotiable item for the supporting Payer.

In still further embodiments the system comprises a claims control process that includes, a waiting period before the Payer is allowed to make a claim.

### DESCRIPTION OF THE DRAWING

FIG. 1 depicts a flowscheme of the method of the invention.

### DETAILED DESCRIPTION

The following presents a simplified summary of one or more embodiments of the invention in order to provide a basic understanding of such embodiments. This summary is not an extensive overview of all contemplated embodiments of the invention, and is intended to neither identify key or critical elements of all embodiments of the invention, nor delineate the scope of any or all embodiments. Its sole purpose is to present some concepts of one or more embodiments in a simplified form as a prelude to the more detailed description that is presented later.

The system comprises a computing platform including a processor and memory. The system further includes an underwriting request routine stored in the memory and executable by the processor. The underwriting request routine is configured to receive requests from an applicant to enroll in the default insurance product, then process the applicant's information through (1) a credit rating bureau using a psychographic profiling system with specific critiques to determine financial eligibility and (2) a medical information bureau to determine pre-existing conditions.

Embodiments of the underwriting analysis determine the amount of insurance needed to comply with a court order or other legal agreement and, if the applicant is eligible, the system calculates the premium.

This innovative underwriting system makes it possible to provide support payment insurance on a group discount basis through nonprofit associations, i.e. Single Parent Association of America and the Child Welfare League of America.

Another embodiment of this method of underwriting makes it possible for Family law firms to use an online system to make insurance part of a settlement agreement, thus providing peace of mind to clients and a negotiable item for the supporting Payer.

In still further embodiments the method comprises a claims control process that includes a waiting period before the Payer is allowed to make a claim.

Turning to FIG. 1, the flowscheme of a method for an underwriting and online quoting system for insuring the continuation of child, alimony, palimony and prenuptial payments and legal expenses for enforcement according to the invention is depicted. At 100, information on proposed insured is submitted online using a specifically designed application. At 110, the underwriting process begins whereby the underwriting system is connected to a credit bureau and medical information bureaus, using our unique selection criteria each question on an application is assigned points when the negative points reach 55 the process stops, the applicant is notified as to why and how to appeal. At 120, requests for higher limits, such as for monthly payments of $2,500 or higher, individual underwriting is required. At 130, for customized payments such as lump sum payments for tuition, summer camp, special education and other benefits, individual underwriting is required. At 140, if the application is approved, the system automatically calculates the premium based on the amount requested and charges to a credit or debit card monthly. At 150, the policy is issued and the insured may print or download policy or request a copy of the policy. At 160, the beneficiary is notified 30 days prior to cancellation of the policy for non-payment. At 170, all information regarding the policy is transmitted to a central database.

While certain embodiments have been described, they are merely explanations and not restrictive of the broad invention, and that this invention not be limited to the specific constructions and arrangements described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

1-7. (canceled)

8. A computer-implemented method for facilitating the underwriting of support payment insurance comprising:
receiving at a server over the Internet an application from an applicant for support payment insurance, wherein the application comprises data relating to age, sex, occupation, work history, geography, credit rating, children visitation rights, support payments in relation to income and medical history of the payer of the support payment;
forwarding the data to a credit rating bureau for processing to determine financial eligibility information of the payer;
forwarding the data to a medical information bureau to determine pre-existing condition information of the payer;
receiving the financial eligibility information and pre-existing condition information from the credit bureau and the medical information bureau;
determining eligibility of the payer for the insurance based on the payer information, the financial eligibility information and the pre-existing condition information; and
calculating a premium for the insurance if the payer is determined to be eligible for the insurance.

9. The method of claim 8, wherein support comprises alimony, spousal support, child support or any combination thereof.

10. The method of claim 9, wherein the credit rating bureau uses a psychographic profiling system with specific critiques to determine financial eligibility of the payer.

11. The method of claim 9, further comprising utilizing fraud prevention techniques in the underwriting process.

12. The method of claim 11, where the fraud prevention techniques comprise terms of the insurance of determining a waiting period before being allowed to make claims, determining a reporting period from a claim event after which the beneficiary of the insurance policy is unable to make claims based on an unintentional event, determining an auto-cancel period for nonpayment of the insurance policy premium or any combination thereof.

13. The method of claim 9, wherein the beneficiary of the insurance policy is notified prior to cancellation of the insurance policy for non-payment.

14. The method of claim 9, wherein eligibility for payments under the insurance policy comprises inability of the payer to pay support due to unintentional circumstances, death of the payer, disability of the payer, unemployment of the payer, active military duty of the payer, qualification of the payer for unemployment benefits or any combination thereof.

15. The method of claim 14, wherein qualification for unemployment benefits by the payer comprises that the payer be registered for work and show proof of a diligent effort to find employment.

16. The method of claim 14, further comprising evidence that the payer's income has been reduced as a result of being called to active military duty.

17. The method of claim 14, wherein if the payer is unable to pay support and the payer is self-employed, the payer's inability to pay support must be caused exclusively by business bankruptcy, damage to business premise by fire, natural disaster, theft, or loss of a supplier or major customer resulting in drastic loss of business.

18. The method of claim 14, wherein payments under the insurance policy are directly deposited in the beneficiary's bank account.

19. A computer-implemented method for obtaining support payment insurance comprising:
receiving at a server over the Internet an application from an applicant requesting to enroll a third party payer for support payment insurance relating to support payments due to the applicant from the payer, wherein the application comprises data relating to age, sex, occupation, work history, geography, credit rating, children visitation rights, support payments in relation to income and medical history of the payer;
forwarding the data to a credit rating bureau for processing to determine financial eligibility information of the payer;
forwarding the data to a medical information bureau to determine pre-existing condition information of the payer;
receiving the financial eligibility information and pre-existing condition information from the credit bureau and the medical information bureau;
determining eligibility of the payer for the support insurance based on the payer data, the financial eligibility information and the pre-existing condition information; and
calculating a premium for the insurance if the payer is determined to be eligible for the insurance.

20. The method of claim 19, wherein support comprises alimony, spousal support, child support or any combination thereof.

21. A computer-implemented method for facilitating the underwriting of support payment insurance comprising:
receiving at a server over the Internet an application from an applicant for support payment insurance, wherein the application comprises data relating to age, sex, occupation, work history, geography, credit rating, children visitation rights, support payments in relation to income and medical history of the payer of the support payment;
forwarding the data to a credit rating bureau for processing to determine financial eligibility information of the payer;
forwarding the data to a medical information bureau to determine pre-existing condition information of the payer;
receiving the financial eligibility information and pre-existing condition information from the credit bureau and the medical information bureau;
determining eligibility of the payer for the insurance based on the payer information, the financial eligibility information and the pre-existing condition information;
calculating a premium for the insurance if the payer is determined to be eligible for the insurance; and
offering a group discount of the premium of the support payment insurance if the payer of the support payment or the payer of the premium of the support payment insurance is a member of an approved organization.
